(19) United States
(12) Patent Application Publication
(10) Pub. No.: US 2011/0022864 A1
(43) Pub. Date: Jan. 27, 2011

(54) REAL-TIME CLOCK

(76) Inventors: Holger Haiplik, Swindon (GB); Dleter Graefje, Notzingen (DE)

Correspondence Address: DICKSTEIN SHAPIRO LLP, 1825 EYE STREET NW, Washington, DC, 20006-5403, US

(21) Appl. No.: 12/841,641

(22) Filed: Jul. 22, 2010

Related U.S. Application Data
(60) Provisional application No. 61/227,991, filed on Jul. 23, 2009.

(30) Foreign Application Priority Data
Jul. 22, 2009 (GB) 0912692.1

(51) Int. Cl. G06F 1/32; G06F 1/26; G06F 1/08

(52) U.S. Cl. 713/322; 713/500

(57) ABSTRACT

A real-time clock circuit, comprising: an oscillator; and a counter, coupled to an output of the oscillator, for generating a real-time clock value. In a first mode the oscillator is configured to generate oscillations and the counter is configured to increment the real-time clock value based on the oscillations. In a second mode the oscillator is stopped, and the counter is configured to retain the real-time clock value at a frozen value.

This application claims the benefit of U.S. Provisional Application No. 61/227,991, filed Jul. 23, 2009.

### BACKGROUND OF THE INVENTION

1. Field of the Invention

The present invention relates to the field of real-time clock generation in electronic devices, and in particular to a real-time clock and associated method for use in low-power modes.

2. Description of the Related Art

Most modern electronic systems or apparatus have or need a system time capability. The real-time clock (RTC), usually consisting of a crystal oscillator and a digital counter of some sort, is a well known building block that is routinely used to provide this system time capability. The RTC maintains a regularly incrementing RTC count value, which can be translated by the system into a system time, or which the RTC may deliver in a desired format.

In many electronic apparatus, and especially portable electronic apparatus, e.g. a battery-operated device, there is a requirement from time to time to remove the main power source, e.g. replacing, or swapping the main battery. For a battery-operated device this can be because e.g. the (non-rechargeable) batteries have become depleted and require changing, or for maintenance purposes. When the main power source is not present, however, the real-time clock will lose its supply voltage and so lose its count value; hence on re-activation the system will no longer have a valid RTC count value from which to derive its system time. Not only is this inconvenient to the user, but this could have further implications on the system, for example resulting in an inability to determine the current system time for DRM (digital rights management) purposes.

There may also be certain system- or software-level requirements which force a product or system manufacturer to provide RTC data for a certain period of time after the main battery source is removed. For example, certain operating systems require a valid system time, and hence a valid RTC count value, still to be available after removal of the main power source for a defined time interval for certification purposes.

It is therefore advantageous to provide a backup power source for the RTC that will provide it with a supply voltage in cases where the main, i.e. primary, power source, e.g. the battery of the battery-operated device, is temporarily absent.

FIG. 1 shows an example of a device 10 employing such a secondary power source.

The device 10 comprises a system 12 and a real-time clock (RTC) 14, which generates a real-time clock value for the system 12. The system 12 may comprise digital processing circuitry, memory, analogue circuitry, or any other electrical components present in electronic devices. The device 10 further comprises a battery 16, which operates as the main, i.e. primary, power source.

In normal operation of the device 10, therefore, the battery 16 provides power to the system 12 and the RTC 14. However, there will be instances when the battery is unable to supply power to the system 12 and the RTC 14. For example, the battery 16 may become discharged, or may be removed from the device 10 for maintenance or replacement. There is also the scenario where the device 10 is dropped, and a battery terminal temporarily loses contact with the device. For these situations, the device 10 further comprises a backup power supply such as a coin cell 18, which supplies power to the RTC 14 so that it may continue to generate a valid RTC count value even after the battery 16 stops providing a power supply.

Thus, the coin cell 18 is used as an alternative power source to provide a supply voltage for the RTC 14 which in this case will be able to maintain operation of the RTC. When the main power source, i.e. the battery 16, is restored the derived system time will still be up-to-date. As a typical RTC supply current is of the order of 1 μA, the coin cell 18 has enough capacity to supply this for a very long time (perhaps in the order of months).

However, in cost-sensitive systems the use of a coin cell may be prohibitively expensive, and furthermore in space-constrained systems the use of a coin cell may be very difficult or even impossible as a coin cell is much larger than common inexpensive surface-mountable passive components or even many integrated circuits. Also a single pass through a reflow soldering operation destroys a lithium coin cell, so either a battery holder has to be soldered to the board and the battery later inserted or in a tabbed construction the coin cell has to be hand-soldered onto the PCB.

Other alternative power sources include gold- or super-capacitors. These capacitors are able to maintain the system time for a reasonable length of time as well (in the order of days or weeks) and are available in different form factors. However, they are also expensive. Most have a form factor as large as coin cells, say 10 mm×10 mm×5 mm, or 7 mm×7 mm×1.8 mm, or 25 mm×15 mm×1.25 mm and many are not re-flow solderable.

There is therefore a need for a real-time clock circuit that consumes an extremely low amount of power, such that an alternative power source with less capacity may be used, allowing the use of power sources that may be both physically small and inexpensive.

### SUMMARY OF THE INVENTION

According to embodiments of the present invention there is provided a real-time clock (RTC) circuit, comprising: an oscillator; and a counter, coupled to an output of the oscillator, for generating a real-time clock value. The RTC is configurable to operate in at least a first mode and a second mode. In the first mode the oscillator is configured to generate oscillations and the counter is configured to increment the real-time clock value based on the oscillations. In the second mode the oscillator is stopped, and the counter is configured to retain said real-time clock value at a frozen value.

There is also provided a method of generating a real-time clock value, comprising, in a first mode: generating oscillations in an oscillator; and generating a real-time clock value based on the oscillations of the oscillator. In a second mode, the method comprises: stopping the oscillator; and retaining the real-time clock value at a frozen value.

The present invention therefore provides an RTC circuit and a corresponding method whereby in a low-power mode the RTC is unclocked, i.e. no oscillations occur within the RTC, but a value of the RTC is maintained, i.e. in a non-zero frozen state. On returning from the unclocked mode to a clocked mode, the system time will not be absolutely correct, but only some time out. Such a time difference is much less inconvenient than completely losing all system time information.

### BRIEF DESCRIPTION OF THE DRAWINGS

For a better understanding of the present invention, and to show more clearly how it may be carried into effect, reference will now be made, by way of example, to the following drawings, in which:

FIG. 1 is a schematic diagram of a device with a real-time clock according to the prior art;

FIGS. 2a and 2b are schematic diagrams of devices according to alternative embodiments of the present invention;

FIGS. 3a and 3b are schematic diagrams of a real-time clock circuit according to different embodiments of the present invention;

FIGS. 3c to 3f are schematic diagrams of oscillators for use with a real-time clock circuit according to the present invention; and

FIG. 4 is a flowchart of a method according to the present invention.

### DETAILED DESCRIPTION

In order to address the cost and space constraints mentioned above, one viable alternative power source is a capacitor. The smaller the capacitor which can be selected, the easier it is to physically integrate it into a system.

A real-time clock (RTC) is usually designed to use very little supply current, but a standard capacitor might still not be enough to provide it with a power supply for more than one minute. For example, assuming a current consumption of 1 μA for a complete RTC, and a target of keeping the system time for even only five minutes in the absence of a primary power source, then 300 μF of capacitance will be needed even if the supply voltage is allowed to droop by one volt (1V). Capacitors with capacitance values required to maintain system time in the order of five minutes or more with a supply voltage droop in the order of one volt (1V) are relatively large, i.e. bulky, and so might not easily fit into the system.

In order to address this issue without having to dramatically drop the current consumption of the RTC when operating normally (which might not even be possible) the present invention utilizes an unclocked backup mode. In this mode, as soon as the removal of the main, i.e. primary, power supply is detected the RTC is effectively frozen. In other words, the RTC is unclocked, i.e. the oscillator is halted or powered down, and the current content of the counter is maintained, i.e. frozen or stored, and not reset. The current consumption of the RTC block will drop significantly in this unclocked mode, and a current consumption of less than 100 nA may be achieved (as will be understood by those skilled in the art, in practice this current may be largely consumed by a power-on-reset circuit). For example, assuming a current consumption for the unclocked RTC of 100 nA, and a target of keeping the real-time clock value for up to five minutes, then only 30 μF of capacitance is needed if the supply voltage is allowed to droop over time by one volt (1V). Capacitors with these capacitance values are readily available in small size, say 1.8 mm×1.6 mm×0.8 mm, less than 5% of the volume of the above mentioned coin cell examples, and relatively cheap, making this an attractive solution.

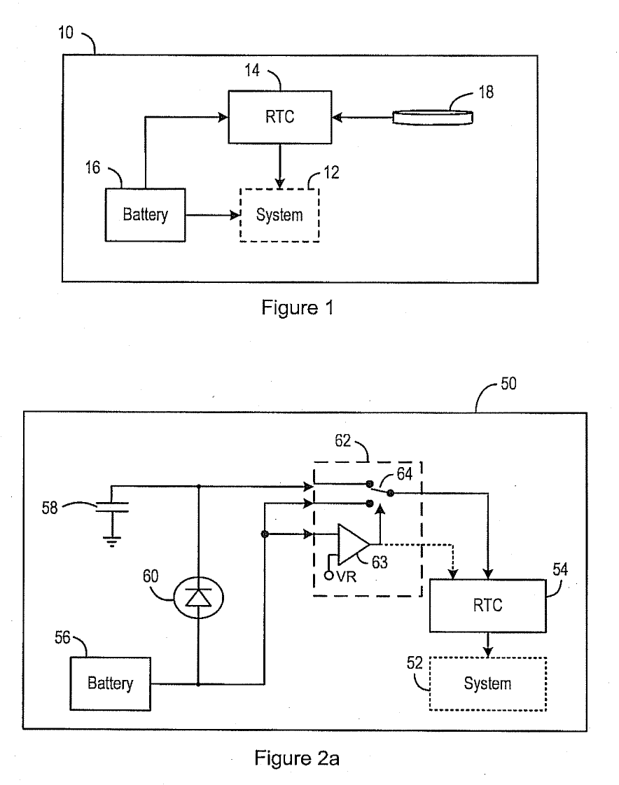

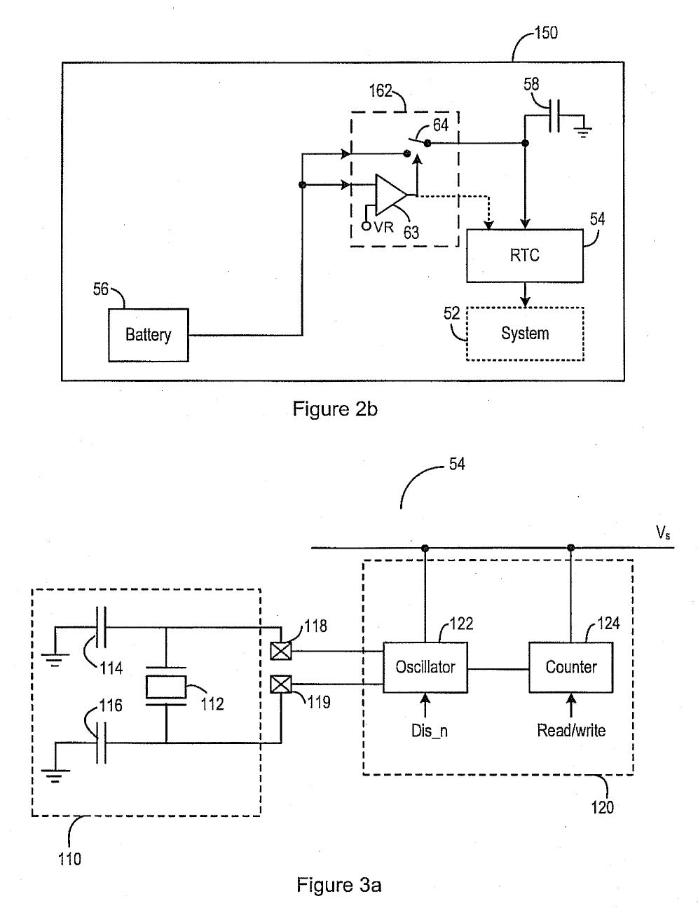

FIG. 2a shows a device 50 comprising an RTC 54 according to embodiments of the present invention. The device 50 is similar to that described with reference to FIG. 1.

The device 50 comprises a system 52, and an RTC 54 which provides a real-time clock value for use by the system 52. As before, the system 52 may comprise any components usually found in electronic devices, such as digital or analogue circuitry, memory, etc. Such features are inessential to the description of the invention and therefore are not included for clarity.

The device 50 further comprises a main power source 56 and a back-up power source 58. In the illustrated embodiment, the main power source 56 is a battery; however, any power source may be contemplated as the main power source, including a connection to a mains power supply or a USB connection, for example. It should be further noted that although power source 56 is shown as a battery, it could be a low drop-out regulator (LDO) powered by a battery or any other solution. The battery may not be used as a power source of the RTC directly, for example if this is not possible due to incompatible supply voltage ranges. Also in the illustrated embodiment, the back-up power source is a capacitor; when operating in a low-power mode, the RTC 54 according to the present invention has sufficiently low power requirements that a standard capacitor, for example having a capacitance of 100 μF or less, is sufficient to run the RTC 54 for up to approximately fifteen minutes (assuming a droop over time of the voltage across the capacitor 58 of 1V and 100 nA of supply current). A larger capacitance would allow operation for a longer period of time; likewise, a lower supply current would allow longer operation, or a smaller capacitor to be used.

While one motivation for the invention is to allow the use of a cheap, inexpensive, physically small capacitor, a benefit of longer operation time in backup mode would be obtained by the use of other power sources that may be contemplated as the back-up power source, such as a coin cell or gold- or super-capacitors.

A first node of the capacitor 58 is coupled to ground, and a second node is coupled to the battery 56 via a diode 60. The diode 60 and battery 56 act as a charging circuit to charge the capacitor 58 when the voltage output by the battery 56 is sufficiently high.

While the diode 60 is a simple and cheap solution, more complex charging circuitry such as a low-dropout regulator (LDO) based charging circuit or a zero-drop diode circuit could offer benefits such as a higher charge voltage on the capacitor. On other occasions a more complex solution may even be required due to the battery voltage range being unsuitable to directly connect to the RTC (even be it through a diode). Such alternative charging circuits will be readily apparent to the skilled person.

The power outputs of both the battery 56 and the capacitor 58 are provided to a monitoring circuit 62. The monitoring circuit 62 compares the voltage level of the battery 56 to a predetermined reference voltage level VR, and controls the selection of one of these sources 56, 58 to provide power to the RTC 54. Generally, the main power source (i.e. the battery 56) is selected to provide power. However, if the voltage output of the main power source falls below VR (for example if the battery 56 is discharged to 1% or less of its capacity, or the voltage level falls to zero because the battery 56 has been removed), the back-up power source 58 is selected to provide power to the RTC 54. In detail the monitoring circuit 62 may actually comprise a resistive divider or other means to scale down the voltage level of the battery before it is applied to the actual inputs of a comparator. The monitoring circuit 62 may also provide control signalling to the RTC 54 as will be described in greater detail below, in order to put the RTC into a power-saving mode.

The monitoring circuit 62 is illustrated as a comparator 63 comparing the voltage output by the battery 56 with an explicit reference voltage VR, and using this comparison to control a two-pole switch 64. Other means of implementing this function will be obvious to one skilled in the art.

Power is also generally supplied to the system 52 by the power source 56 when available, although this is not illustrated. Power source 58 may also be used to power parts of the system 52 requiring very low current, such as static memory for power management configuration settings and scratch data storage.

In an alternative embodiment, illustrated as device 150 in FIG. 2b, the back-up power source 58 may be connected to the power output of a modified monitoring circuit 162, and not as a power input. In this embodiment, the modified monitoring circuit 162 detects the voltage level of the main power source 56 (possibly a battery or possibly an LDO driven from a battery or some other source) and decouples the power supplied by the main power source 56 in the event that the voltage level falls below a threshold value, for example. In this instance, the back-up power source 58 automatically takes over and supplies power to the RTC 54.

The RTC 54 is in one embodiment implemented on an integrated circuit. The device 50, 150 may be a portable device, for example a computing device; a laptop; a notebook computer; a PDA; a media player; an MP3 player; a video player; a portable television device; a communication device; a mobile telephone; a mobile email device; a GPS device or a navigation device, or any other battery operated device.

The table below illustrates, according to one embodiment, the different operations or states of each component in the different power states. PPS denotes the primary power source 56 and SPS denotes the secondary power source 58.

| | On | Off | Backup | Zero power |
|---|---|---|---|---|
| Device | On | Off | Off | Off |
| PPS | Active | Active | Absent/Depleted | Absent/Depleted |
| SPS | N/A | N/A | Active | Absent/Depleted |
| Oscillator | Enabled | Enabled | Stopped | Stopped |
| Counter | Counting | Counting | Frozen | Off |

The device 50, 150 is firstly operable in an “on” mode, where the device is powered by the primary power source (PPS) 56 and the RTC is fully operational. That is, an oscillator of the RTC is enabled, and it increments a counter to continually update a real-time clock value based on the oscillation signal provided by the oscillator.

The device 50, 150 is also operable in an “off” mode, where the power reserves in the main power source 56 are low, e.g. between 1% and 5% of capacity, or where the device has simply been switched off by a user or is in standby mode. In such modes the system 52 is most likely to be mainly powered down (i.e. only a small amount of power is consumed relating to essential systems), but the main power source 56 still has sufficient power reserves to supply power to the RTC 54, which generally consumes much less power than the system 52.

In the off mode, the RTC 54 continues to generate an accurate real-time clock value. That is, an oscillator in the RTC 54 continues to oscillate, and a real-time clock value, derived from those oscillations, is incremented and updated in the RTC 54.

According to embodiments of the present invention, the device 50, 150 is also operable in a “backup” mode, where the main power source may provide no power to either the RTC 54 or the system 52. This may occur owing to the main power source (e.g. the battery 56) becoming completely (or nearly completely) depleted, or being removed from the device, or malfunctioning, for example. In the backup mode, the secondary power source (SPS, e.g. the capacitor 58 in FIGS. 2a and 2b) provides power to the RTC 54. Thus, the device 50, 150 itself is off in this power state, the primary power source is absent or depleted, and the secondary power source is active.

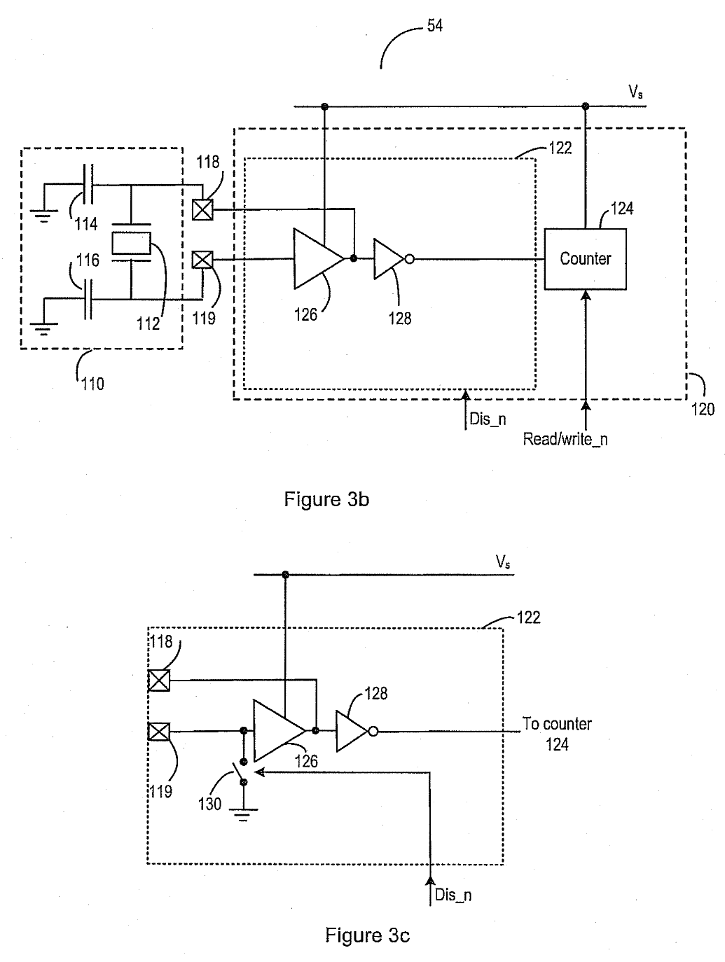

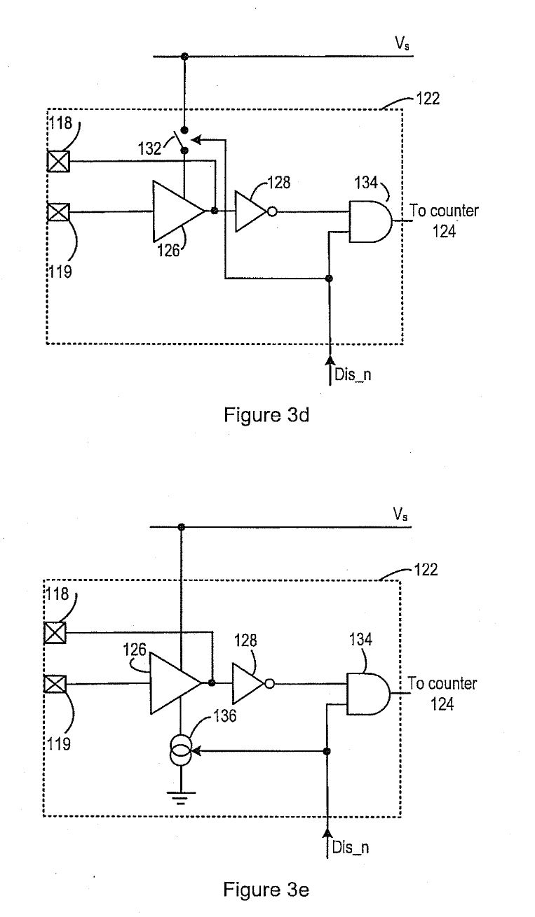

Further, in the backup mode the RTC 54 itself operates in a low power mode, whereby the oscillator of the RTC is powered down, and the real-time clock value is maintained at substantially the same value that was reached before the device 50, 150 moved into the backup mode (although some variation might occur owing to any spurious clock signal edges that might occur during the transition into the backup mode). Alternatively, some offset may be applied to the value stored in the counter, for example in order to proactively compensate for an amount of time the RTC generator is expected to be operating in the backup mode. A more detailed explanation of this mode is provided with reference to FIGS. 3a to 3f.

The device 50, 150 also has a “no power” mode, in which neither the main power source nor the secondary power source provide any power, for example because they have both become depleted. In this mode, the real-time clock value in the RTC is lost from memory because power is not supplied to the RTC 54 to maintain it. A power-on-reset circuit (not illustrated) resets the real-time clock value of the RTC 54 to zero after the device 50, 150 moves from the no power mode on reconnection of the main, i.e. primary power source 56.

The device 50, 150 can move between the various power modes according to the levels of power in the main and secondary power sources. When moving to the backup mode, the RTC 54 may receive a control signal from the system 52 instructing it to move to a low-power mode. Alternatively, the monitoring circuitry 62 may detect that the main power source output is low or zero and provide a control signal to the RTC 54 to switch to the low-power mode.

FIG. 3a shows a real-time clock system 54 according to an embodiment of the present invention.

The system 54 comprises a resonant circuit 110 and a real-time clock generator 120 powered by a supply voltage V_{S}. The resonant circuit 110 is coupled to the RTC generator 120, and in the illustrated embodiment is provided off-chip, utilizing pins 118, 119 to couple the two together.

The resonant circuit 110 comprises a resonant element 112 for example a piezoelectric crystal such as a quartz crystal, or a ceramic resonator, with two terminals. Respective nodes of two load capacitors 114, 116 are coupled to each of the terminals, with the remaining nodes of the load capacitors 114, 116 connected to ground. The load capacitors 114, 116 are shown off-chip, but can be on-chip as well. In some embodiments there might be other passive components, e.g. a resistor between the two terminals 118, 119. In other embodiments the resonant circuit 110 is connected between only one terminal, e.g. 118, and ground and the oscillator 122 has only one terminal, e.g. 118.

The RTC generator 120 comprises an oscillator 122 coupled to a counter 124. The oscillator 122 is coupled to the pins 118, 119 and co-operates with the resonant circuit 110 to generate an oscillating signal at a resonance frequency of the resonant circuit, as will be familiar to those skilled in the art. For example, the resonant circuit 110 may have a resonant frequency of 32.768 kHz, which allows a convenient conversion to 1 Hz; however, other frequencies are contemplated by the present invention. The oscillator 122 is illustrated on the same chip as the counter 124; however, in other embodiments, some or all of the oscillator 122 circuitry may be on off-chip, for example with the resonant element 112.

The counter 124 receives the clock signal output of the oscillator 122. On one (or possibly both) edges of each cycle of the clock signal, the count value stored in the counter increments, producing a count value representing the number of clock edges received since the counter 124 powered-up (assuming the counter is reset to zero at its initial power-up). This real-time clock value may be accessed by the system 52. That is, the counter 124 stores a value that is accessible by the system 52, and which may be converted by the system to a time and date using a known conversion algorithm. In one embodiment, the counter 124 comprises a register, for example a 32-bit register. In one embodiment, this register may be updated synchronously each cycle, possibly in parallel, from a string of divide-by-2 stages in the counter, to ensure the value output is valid even while the clock is still rippling through these stages. In another embodiment, the counter may be accessible directly by the system, with care taken to sample the outputs with valid timing.

The counter 124 may also in some implementations be settable from an input from the system, albeit with security precautions to avoid abuse in Digital Rights Management scenarios.

Both the oscillator 122 and the counter 124 receive power from a supply rail providing a supply voltage V_{S}. In operation this may be coupled to either the main power source or the backup power source as discussed above. However, in alternative embodiments, the oscillator 122 and counter 124 may receive power from separate supply rails.

A control signal Dis_n is provided to the oscillator 122. When Dis_n is a first level, say high, the oscillator 122 operates in a first mode of operation. When Dis_n is a second level, say low, the oscillator 122 operates in a second mode of operation. The control signal may be derived from aforementioned control signalling from the monitoring circuit 62, 162, for example on detection of low or zero power in the main power source. Alternatively it may be generated by the system 52. In principle it could be generated directly by user input. However this visible clock-stopping signal would enable possible DRM abuse of the device 50, 150, so would not be a feature that device manufacturers would desire.

In the first mode of operation, e.g. the “off” mode above, the oscillator 122 is operational and co-operates with the resonant circuit 110 to supply the counter 124 with a clock signal. The counter 124 therefore continually increments, generating a real-time clock value based on the oscillations of the oscillator 122.

In the second mode of operation, for example the “backup” mode mentioned above, a disable signal is provided to the oscillator 122 as a control signal, stopping it. In this mode the oscillator consumes negligible power, and its output signal settles to a constant level, ground for example. The clock signal applied to the counter 124 is then constant, so it continues to hold a constant real-time clock value, i.e. the count value is frozen.

As shown in more detail in FIG. 3b, the oscillator 122 may contain an amplifier stage 126 connected between pins 118 and 119. This amplifier 126 supplies energy to initiate and sustain the oscillations in cooperation with the resonant circuit 110. The amplifier may be a simple CMOS inverter with a resistor connected between the two pins 118, 119 to set the inverter into a high-gain region. Alternatively it may be a more complex circuit as known to provide oscillation amplitude stabilisation or better supply rejection.

As mentioned above, alternative implementations of the oscillator 122 may use only one pin, with one port of the resonant circuit and an amplifier output connected to that pin and the other resonant circuit terminal grounded.

The amplifier output signal may be amplified by subsequent gain stages, for example one or more CMOS inverters 128 (of which one is shown), to provide a rail-to-rail signal with faster edges, to provide a squared-up signal better suited for clocking the counter 124.

However, it is possible that fluctuations in the system 54 may cause a signal to be produced by the oscillator 122 in spite of its being stopped. Therefore, the real-time clock value of the counter 124 may only be described as “substantially constant” in the second mode. To overcome this problem, in one embodiment, the output of the oscillator 122 may be held at a constant low or high level while the RTC system 54 operates in the second mode of operation.

FIGS. 3c to 3f illustrate various means for stopping the oscillator 122.

In the circuit of FIG. 3c, the input of the amplifier 126 may be pulled to ground, for example by action of the disable signal Dis_n on a switch 130. This forces the output of the amplifier 126 high (for example, in an arrangement where the amplifier 126 is a CMOS inverter), thus forcing the output of the oscillator after the inverter 128 to a constant, low, level. Furthermore, in the case where the amplifier 126 is a CMOS inverter, since the CMOS inverter 126 input is grounded, no current flows through the inverter, so the amplifier consumes negligible power.

In the circuit of FIG. 3d, a series switch 132 is operable under the disable signal Dis_n to disconnect the supply voltage from the amplifier 126 and possibly the squaring circuit 128, so all nodes in the oscillator 122 will drift down to ground and no supply current will be consumed.

In this circuit, it may take some time for the output to decay to ground. Especially as the output drifts past the input logic threshold of the counter input, spurious noise pulses may succeed in clocking the counter 124. Indeed such pulses may clock some stages but not succeed in clocking others, possibly corrupting the count value. To avoid this, the oscillator output may be set low, conveniently by adding an AND gate 134. When Dis_n is low, the output of the AND gate 134 will be pulled low immediately, thus avoiding the danger of noise pulses propagating to the oscillator output, and keeping the real-time clock value constant. Other similar simple logic methods to implement holding the output of the oscillator 122 at a constant level, high or low, by a logic gate, one input of which is held at a fixed logic level in the second mode and another logic level in the first mode could be derived by one skilled in the art.

FIG. 3e illustrates a case where the amplifier 126 is a more complex amplifier, biased from a current source 136. In this case the bias current source 136 is turned off under action of the disable signal Dis_n, placing the oscillator 122 in a state where negligible supply current is taken. Again, and depending on the amplifier design, it may be safest to pull the output down to ground with an AND gate 134 or similar as shown.

It will be apparent to those skilled in the art that all three of these embodiments may be employed in the same oscillator circuit 122, and this is shown in FIG. 3f.

In the first mode, not only is supply current required by the amplifier 126, but the switching of the subsequent nodes in the squaring-up circuitry 128 and the counter 124 also requires significant supply current. The latter is mainly due to having to supply the charge needed to charge up the device and parasitic capacitances present on each circuit node each time the logic level changes. There is also some “shoot-through” current that may pass though say the series PMOS and NMOS transistors of the squaring-up inverter 128 during the time when the amplifier 126 output is near mid-rail.

In the second mode, not only is the amplifier 126 current reduced to near zero, but also the counter 124 and the intermediate gates are all no longer clocked, i.e. unclocked, so all nodes are at constant voltage and require no charging current. The squaring inverter 128 will also receive a solid logic level, so will not be subject to shoot-through current. Thus the supply current consumed will be near zero, reduced to the off-state sub-threshold leakage current of the MOS and the leakage current of the device junctions, typically a few pA per logic gate.

The present invention therefore provides a mode in the RTC 54 whereby relatively low amounts of power are consumed therein. In the low-power mode, the power usage of the system 54 may be as low as that required to maintain the current value of the real-time clock value of the counter 124, i.e. just enough to compensate for leakage currents.

Maintaining the real-time clock value at a substantially constant value of course adds an error when moving from the backup mode back to the off mode (or an “on” mode).

The real time clock value will be in error by a count value difference corresponding to the amount of time the RTC 54 was in the backup mode. As will be described later, this is not seen as a major problem; however, in some embodiments the device 50, 150 comprises means for correcting the real-time clock value. Such correcting means may include an input for receiving the input of a user, correcting the real-time clock value; it may include a receiver for receiving a telecommunication signal, from which the real-time clock value can be corrected. Numerous methods may be thought of by those skilled in the art for correcting the real-time clock value.

However, as mentioned above, the error introduced by not clocking the real-time clock value is thought to be insignificant when considered in the light of other errors present in the real-time clock value of the RTC 54. Many errors are inherent in the resonator circuit 110 and in the RTC generator 120. Changes in temperature, crystal/resonator inaccuracy, and ageing of the crystal/resonator 112 all add to errors in the real-time clock value. In the RTC generator 120, the trim of the oscillator 122 may be inaccurate, adding to the errors in the real-time clock value. The errors introduced in the low-power mode are likely to be insignificant, or acceptable, or of a similar size, in comparison to the other errors in the RTC 54.

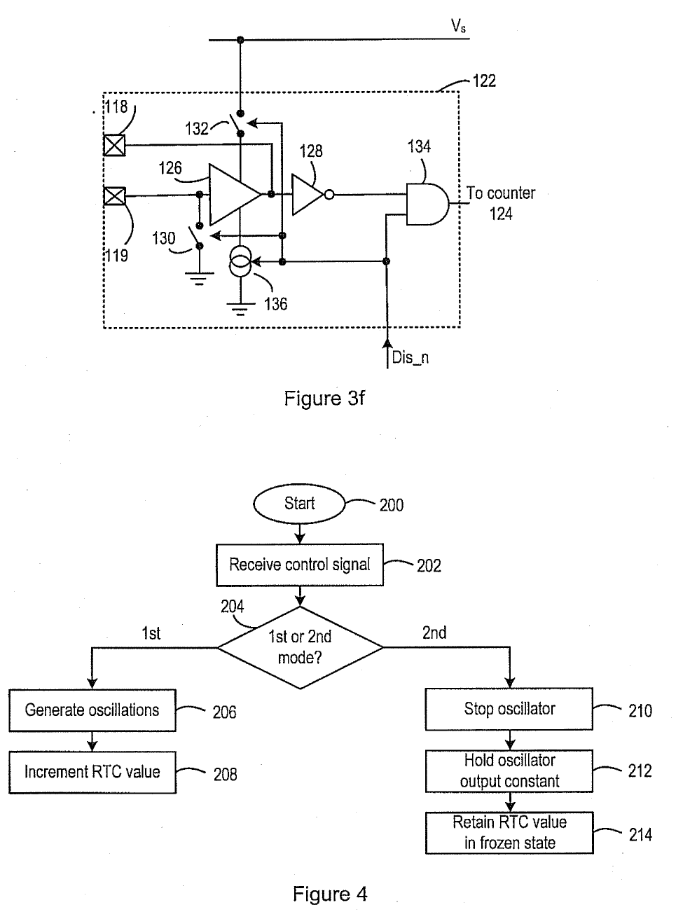

FIG. 4 is a flowchart of a method of generating a real-time clock value in a RTC generator according to the present invention. The method begins in step 200.

In step 202, a control signal is received indicating whether the RTC generator should operate in a first or a second mode. The control signal may be received from the system 52, or monitoring circuitry 62. The latter case has the advantage that security of the RTC value is easier to maintain (for example for DRM purposes). In step 204, the RTC generator determines which mode it should operate in. If no control signal is received, the RTC generator may continue to operate in its current mode.

Particularly in an integrated circuit implementation, the control signal may be gated, i.e. forced into a fixed logic level, as a result of a configuration setting stored within the integrated circuit, to prevent the second mode from occurring regardless of the power state. This configuration setting may be stored in on-chip non-volatile memory (NVM), to allow this setting to be configured in the factory test procedure of an integrated circuit. Thus the same integrated circuit, albeit pre-configured differently, would not stop the clock or the counter in backup mode, and could be used in systems where the power saving is not important, or where preserving real-time clock value accuracy is more important. For example, where a coin cell is used, the current saved is small compared to the self-discharge current of the coin cell.

If the RTC generator operates in the first mode, e.g. the “off” mode or an “on” mode, the method proceeds from step 204 to step 206, where oscillations are generated, for example in an oscillator. A clock signal is incremented in a counter based on those oscillations (step 208).

If the RTC generator operates in the second mode, e.g. the backup mode, the method proceeds from step 204 to step 210, where the oscillator is stopped. In order to overcome a problem of occasional oscillations, the output of the oscillator is held constant in step 212. In step 214, a value of the real-time clock value, i.e. a non-zero value, is retained in a frozen state in the counter, as described above. The retained value may be equal to the value in the counter prior to the RTC generator moving to the second mode. Alternatively, some offset may be applied to the value stored in the counter, for example in order to proactively compensate for an amount of time the RTC generator is expected to be operating in the second mode.

The present invention therefore provides an RTC circuit and a corresponding method whereby in a low-power mode the RTC is unclocked, but a count value of the RTC is retained. On returning from the unclocked mode to a clocked mode, the system time will not be absolutely correct, but only a little time out. This is much less inconvenient than completely losing all system time information.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A real-time clock circuit, comprising:
an oscillator; and
a counter, coupled to an output of the oscillator, for generating a real-time clock value;
wherein the real-time clock circuit is configurable to operate in at least a first mode and a second mode,
wherein in the first mode the oscillator is configured to generate oscillations and the counter is configured to increment the real-time clock value based on the oscillations, and
wherein in the second mode the oscillator is stopped, and the counter is configured to retain said real-time clock value at a frozen value.

2. A real-time clock circuit as claimed in claim 1, wherein in the first mode power is supplied to at least part of the real-time clock circuit by a first power source, and in the second mode power is supplied to said at least part of the real-time clock circuit by a second power source.

3. A real-time clock circuit as claimed in claim 2, wherein the second power source comprises a capacitor.

4. A real-time clock circuit as claimed in claim 3, wherein the capacitor has a capacitance of 100 μF or less.

5. A real-time clock circuit as claimed in claim 2, wherein the real-time clock circuit is configured to operate in the second mode when a voltage supplied by the first power source is below a threshold value.

6. A real-time clock circuit as claimed in claim 1, wherein in the second mode the oscillator is stopped by being disabled or powered down.

7. A real-time clock circuit as claimed in claim 1, wherein in the second mode the output of the oscillator is held at a constant level.

8. A real-time clock circuit as claimed in claim 7, wherein the output of the oscillator is held at a constant level by a logic gate, one input of which is held at a fixed logic level in the second mode.

9. A real-time clock circuit as claimed in claim 1, further comprising:
means for correcting the real-time clock value after the real-time clock circuit has moved from the second mode to the first mode.

10. A real-time clock circuit as claimed in claim 1, wherein the oscillator is a crystal oscillator.

11. An integrated circuit, comprising a real-time clock circuit as claimed in claim 1.

12. An integrated circuit comprising a real-time clock circuit as claimed in claim 2, comprising a switch coupling said first power source to the real-time clock circuit in said first mode and decoupling it in said second mode.

13. An integrated circuit as claimed in claim 11, further comprising a register for configuring the real-time clock circuit to only operate in said first mode.

14. A device comprising an integrated circuit as claimed in claims 11.

15. A device according to claim 14 wherein the device is a portable electronic device.

16. A device according to claim 14 wherein the device is at least one of: a computing device; a laptop; a notebook computer; a PDA; a media player; an MP3 player; a video player; a portable television device; a communication device; a mobile telephone; a mobile email device; a GPS device; a navigation device; or any other battery-operated device.

17. A method of generating a real-time clock value, comprising, in a first mode:
generating oscillations in an oscillator; and
incrementing a real-time clock value based on the oscillations of the oscillator;
and further comprising, in a second mode:
stopping the oscillator; and
retaining the real-time clock value at a frozen value.

18. A method as claimed in claim 17, further comprising:
in the first mode, receiving power from a first power source; and
in the second mode, receiving power from a second power source.

19. A method as claimed in claim 18, further comprising:
switching from the first mode to the second mode when the power supplied by the first power source falls below a threshold.

20. A method as claimed in claim 17, further comprising:
in the second mode, holding an output of the oscillator at a constant level.

21. A method as claimed in claim 17, further comprising:
correcting the clock value after moving from the second mode to the first mode.

22. A real-time clock circuit, comprising:
an oscillator for generating an oscillation signal;
a counter, coupled to the oscillator, for incrementing a real-time clock value based upon said oscillation signal; and
an input for receiving a control signal for controlling the operational mode of the real-time clock circuit, wherein in one operational mode the oscillator is stopped and the counter retains the real-time clock value.

23. A real-time clock circuit, comprising:
an oscillator;
a counter, coupled to said oscillator, for generating a real-time clock value; and
an input for receiving a control signal stopping the oscillator.

24. A real-time clock circuit as claimed in claim 23, further comprising:
oscillator stopping circuitry for stopping the oscillator when the control signal is active.

25. A device comprising
a real-time clock circuit as claimed in claim 23;
a first power source;
a second power source;
voltage detection circuitry monitoring the first supply voltage to activate the control signal when the first supply voltage falls below a predetermined threshold; and
supply switching circuitry coupled to the control signal to disconnect said first power source from said real-time clock circuit when the control signal is active.
